(19) United States
(12) Patent Application Publication
(10) Pub. No.: US 2013/0337221 A1
(43) Pub. Date: Dec. 19, 2013

(54) COATED MEMBER FOR MOVEMENT RELATIVE TO A SURFACE AND METHOD FOR MAKING THE COATED MEMBER

(71) Applicants: Sudhir Brahmandam, Irwin, PA (US); Dave Siddle, Greensburg, PA (US); Irene Spitsberg, Export, PA (US)

(72) Inventors: Sudhir Brahmandam, Irwin, PA (US); Dave Siddle, Greensburg, PA (US); Irene Spitsberg, Export, PA (US)

(73) Assignee: Kennametal Inc., Latrobe, PA (US)

(21) Appl. No.: 13/525,577

(22) Filed: Jun. 18, 2012

(51) Int. Cl. B32B 3/06; B05D 3/00

(52) U.S. Cl. 428/101; 427/331

(57) ABSTRACT

A coated member, as well as a method for making the coated member, adapted for movement relative to a surface wherein a clearance distance between the coated member and the surface exists in a critical region of the coated member. The coated member has a finished size in the critical region. The substrate has an undersized substrate region of a minimum undersizing depth, which is equal to about seventy-five percent of the clearance distance. The undersized substrate region corresponds to the critical region of the coated member. A finished coating scheme is on the undersized substrate region wherein the finished coating scheme is the result of an oversized coating scheme being finished to form the finished coating scheme wherein the coated member is of the finished size in the critical region.

### BACKGROUND

The invention pertains to a coated member for movement relative to a surface, and a method for making the coated member. More specifically, the invention pertains to a coated member for movement relative to a surface, and a method for making the coated member wherein the coating scheme provides resistance against erosion and/or corrosion in an environment requiring tight tolerances between the coated member and the surface. By providing such a coating scheme, there will be an improvement in the effective life and performance of the coated member, as well as a reduction in the premature and unpredictable failures of the coated member. These improvements increase the overall value of the coated member.

Certain components used in various linear sliding applications such as, for example, a plunger in a reciprocating pump, and rotating applications such as, for example, an impeller used to generate differential pressure in a pump, are subjected to abrasive, erosive and corrosive solid particles, fluids, and slurries. As one can appreciate, excessive abrasion, erosion, and/or corrosion is detrimental to the performance of the article-in-question, e.g., reciprocating pump and centrifugal pump. A condition common to many of these linear sliding and rotating applications is a requirement for tight tolerances between the parts that move relative to one another. For example, tight tolerances are necessary to maintain an adequate seal between sliding mating parts such as, for example, the plunger and its adjacent, corresponding seal in a reciprocating pump or the impeller and its adjacent housing in a centrifugal pump. While the specific magnitudes can vary with the specific application, in general, a typical tight tolerance is as tight as ±0.0005 inches (+12.7 micrometers) on a part with a diameter equal to at least 6.5 millimeters and with a surface finish requirement equal to between about 4 and about 16 microinches (0.1-0.4 micrometers) Ra.

Heretofore, a typical process to make such a coated part with a tight tolerance has been to: undersize the component, deposit an oversized coating scheme thereon to accommodate for any distortion or non-concentricity conditions, and then remove material from the oversized coating using established machining techniques until the component meets the tolerance specifications. Due to the hardness and low toughness of the coating, one drawback with this earlier typical process is the need to use expensive machining techniques to bring the component into compliance with tolerance specifications. Because of these expensive machining techniques, current practice attempts to minimize the extent of grinding necessary to meet the dimensional requirements.

One way to minimize the extent of grinding is to undersize the component to a depth comparable to the tolerance requirement (for example, about 10 micrometers) and then deposit a coating that is just moderately thick enough (for example, about 7 micrometers to about 10 micrometers), and then grind the oversized coating to meet specifications. U.S. Pat. No. 6,212,997 B1 discloses this kind of process. The coating thickness on the components using this method ranges between about 3 micrometers and about 10 micrometers due to a combination of the tolerances of the grinding operation and the concentricity of the component.

Typical parts used in low friction applications that have to meet tight dimensional tolerance requirements include various automotive applications such as, for example, bearings, gears and the like. For these low friction-tight tolerance applications, a part with a coating having a thickness between about 3 micrometers and about 10 micrometers is sufficient because the coated surface experiences relatively uniform wear. However, there are applications (e.g., handling abrasive slurries) in which the components do not experience relatively uniform wear. For a component (or part) used in such a non-uniform wear application, a part with a coating thickness equal to between about 3 micrometers and about 10 micrometers would most likely experience premature and unpredictable failure. An examination of premature failures in handling of abrasive slurries revealed an unexpected cause of these premature failures.

It is known that slurries comprise abrasive hard particles carried in a fluid. The hard particles vary in size from sub-micrometer to nearly about 100 micrometers in size, and even greater in some instances. Under normal operating conditions, these hard particles flow over the surface of the part thereby causing erosive and/or corrosive damage. The purpose of the coating on the part is to resist the erosive and/or corrosive damage caused by the flow of the hard particles. Further, it is known that during operation, some hard particles become trapped between the component (e.g., plunger or impeller) and the surface to which it has relative movement (e.g., seals or the walls of the pump). Because the tolerance distance between the coated component and the surface to which it has relative movement is small (e.g., in the order of about 25 micrometers), the sizes of the hard particles that become trapped are also small (i.e., about 25 micrometers or less). Due to their small size, the negative impact of these trapped small hard particles has been ignored for the most part. Yet, these small trapped hard particles appear to have a meaningful negative impact on the useful life of the coated member that is greater than previously thought.

As discussed in Handbook of Micro/Nanotechnology, edited by Bharat Bhushan, CRC Press Ltd., (1999), contact mechanics principles show that when a particle is in contact with a surface, it can cause sub-surface failure because the maximum shear stress due to the contact is below the surface. The depth to which the maximum shear stress can extend is termed the “critical depth”. In elastic contact conditions, the maximum shear stress can extend to a critical depth equal to about one-tenth of the particle size. Thus, for example, in a situation in which the hard particles are of a size equal to 25 micrometers, the critical depth on the coated member can be about 2.5 micrometers. What has been found is even though the critical depth remains within the coating, appreciable shear stresses still exist well below the critical depth.

Sub-surface shear stresses below the critical depth can extend to a depth more than five times the critical depth. Sub-surface shear stresses can damage the coating-substrate interface. These sub-surface shear stresses also can plastically deform the substrate itself. Damage to the coating-substrate interface, as well as plastic deformation of the substrate, can result in localized spalling of the coating that results in exposing the substrate (e.g., steel) to the corrosive environment. Exposure of the substrate to corrosive environment leads to premature and unpredictable failure of the coated members. It thus becomes apparent that it would be highly desirable to provide a coated member for movement relative to a surface that has a coating scheme with sufficient thickness so that the sub-surface shear stresses do not extend into the coating-substrate interface or into the substrate itself. It would be highly desirable to provide a method for making such a coated member. In other words, it would be highly desirable to provide a coated member for movement relative to a surface that has a coating with sufficient thickness so that the sub-surface shear stresses extend to such a depth as to remain within the coating. It would be highly desirable to provide a method for making such a coated member.

For a coated member that uses a coating of a sufficient thickness so that the sub-surface shear stresses extend to such a depth as to remain within the coating, it would be highly desirable to ensure that spalling of the coating does not occur since spalling can expose the substrate to the erosive and/or corrosive environment. There would be an advantage to using a coating scheme (or coating architecture) that optimizes the ductility and erosion/corrosion-resistance properties of various coating materials. One approach would be to use a multi-layer coating architecture in which ductile, corrosion-resistant metal interlayers are between hard ceramic layers. Such an approach would provide both ductility and resistance to the detrimental effects (e.g., erosion and/or corrosion) of a medium like an abrasive slurry. Therefore, it would be highly desirable to provide a coated member for movement relative to a surface that has a coating scheme that comprises a multi-layer coating architecture wherein ductile, corrosion-resistant metal interlayers are between hard ceramic layers so as to provide both ductility and erosion-resistance and corrosion-resistance. It would be highly desirable to provide a method for making such a coated member.

### SUMMARY

In one form thereof, the invention is a coated member adapted for movement relative to a surface wherein a clearance distance between the coated member and the adjoining surface when mapped into the coated member surface exists in a critical region of the coated portion of the member. The coated portion of the member has a finished size that lies in this critical region. The coated member further has a substrate, which has an undersized substrate region of a minimum undersizing depth wherein the minimum undersizing depth is equal to about 75% of the clearance distance. The undersized substrate region corresponds to the critical region of the coated member. A finished coating scheme is on the undersized substrate region wherein the finished coating scheme is the result of the treatment or finishing of an oversized coating scheme to form the finished coating scheme wherein the coated member is of the finished size in the critical region.

In yet another form thereof, the invention is a method for making a coated member adapted for movement relative to a surface wherein a clearance distance between the coated member and the surface exists in a critical region of the coated member and wherein the coated member having a finished size in the critical region. The method comprising the steps of: providing a substrate with an undersized substrate region having a minimum undersizing depth; the undersized region corresponding to the critical region of the coated member, and wherein the minimum undersizing depth being equal to about 75% of the clearance distance; depositing an oversized coating scheme to the undersized substrate region; and finishing the oversized coating scheme to form a finished coating scheme whereby the coated member has the finished size in the critical region.

### BRIEF DESCRIPTION OF THE DRAWINGS

The following is a brief description of the drawings that form a part of this patent application:

FIG. 1 is a sectional view of a portion of a reciprocating pump showing the relationship between the pump plunger and the seal wherein the pump plunger is a component that moves relative to the surface of the seal;

FIG. 2 is a diagrammatic view of the plunger (i.e., coated member) and the seal, which includes the surface wherein in operation the plunger moves relative to the seal;

FIG. 3A is a diagrammatic view of the undersized substrate region of the substrate of the plunger;

FIG. 3B is a diagrammatic view of the undersized substrate region of the substrate with the oversized coating layer thereon;

FIG. 3C is a diagrammatic view of the undersized substrate region of the substrate after the oversized coating layer has been treated to remove some of the coating material to wherein the critical region of the coated member achieves the finished size; and

FIG. 4 is a diagrammatic view showing the dimensional relationships in the critical region of the coated member.

### DETAILED DESCRIPTION

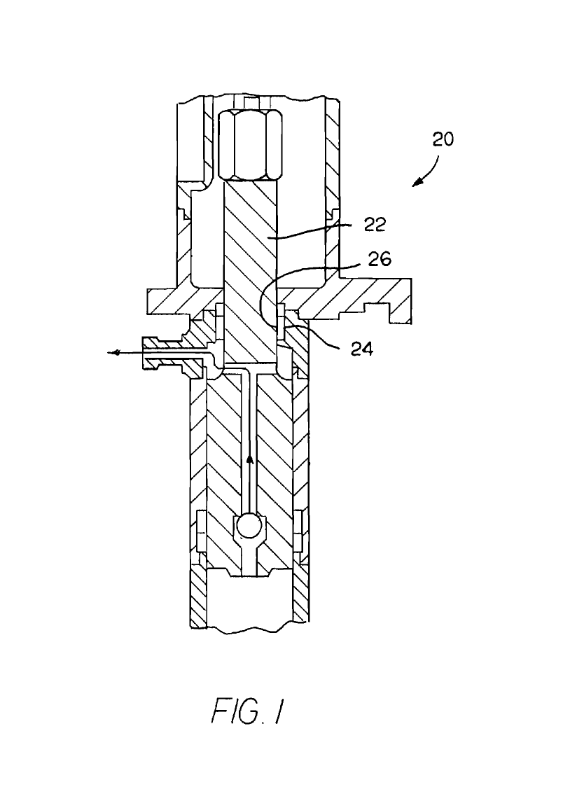

Referring to the drawings, FIG. 1 illustrates a portion of a reciprocating pump generally designated as 20. Reciprocating pump 20 has a structure generally along the lines of the pump disclosed in U.S. Pat. No. 6,212,997 B1 to McCollough et al. wherein the entirety of U.S. Pat. No. 6,212,997 is incorporated by reference herein. FIG. 1 shows a coated plunger 22, which has a plunger shaft, and a seal 24, which has a seal surface 26. The coated plunger 22 is a coated member adapted for movement relative to a surface, which is the seal surface 26. The region of the coated plunger 22 that moves relative to the seal surface 26 is the critical region 30 (see FIG. 2) of the coated plunger, i.e., the critical region of the coated member. There should be an appreciation that the actual size of the critical region (see bracket 30 in FIG. 2) of the coated member 22 can vary depending upon the nature and extent of the movement of the coated member 22 relative to the surface 26.

In this specific embodiment and as shown in FIG. 2, the length of the stroke of the coated plunger 22 impacts the size of the critical region 30. FIG. 2 shows that the axial length 32 of the seal 24 is less than the axial length 31 of the critical region (see bracket 30) of the coated member 22. This is due to the fact that the coated member 22 moves in a reciprocating manner relative to the seal 24. The extent of the reciprocal movement is such that the portion of the coated member 22 that cooperates (or affects a seal) with the seal surface 26 has an axial length 31 to define the critical region 30. Therefore, the region of the coated member 22, i.e., the critical region 30, would have a larger axial length than the seal 24 in that axial length 31 of the critical region 30 is greater than axial length 32 of the seal 24.

Still referring to FIG. 2, the coated member (coated plunger 22) has a finished size 36 in the critical region 30. When the relative spatial positions of the coated member 22 and the seal 24 are established, i.e., mapped, there is a clearance distance 40 there between. In other words, there is a clearance distance 40 between the coated member 22, which has the finished size 36, and the surface 26 (of the seal 24) in the critical region 30 of the coated member 22. The drawing of FIG. 2 exaggerates the relative size of the components to be instructive about the relationship between the components and the clearance distance 40. There should be an appreciation that the magnitude of the clearance distance 40 can vary depending upon the nature of the specific application. An exemplary range for the clearance distance 40 can range between about 2 microns to about 250 microns. Alternate ranges for the clearance distance 40 are: (1) between about 5 microns and about 125 microns; (2) between about 10 microns and about 50 microns; (3) and between about 20 microns and about 30 microns. One exemplary clearance distance 40 is equal to about 25 micrometers.

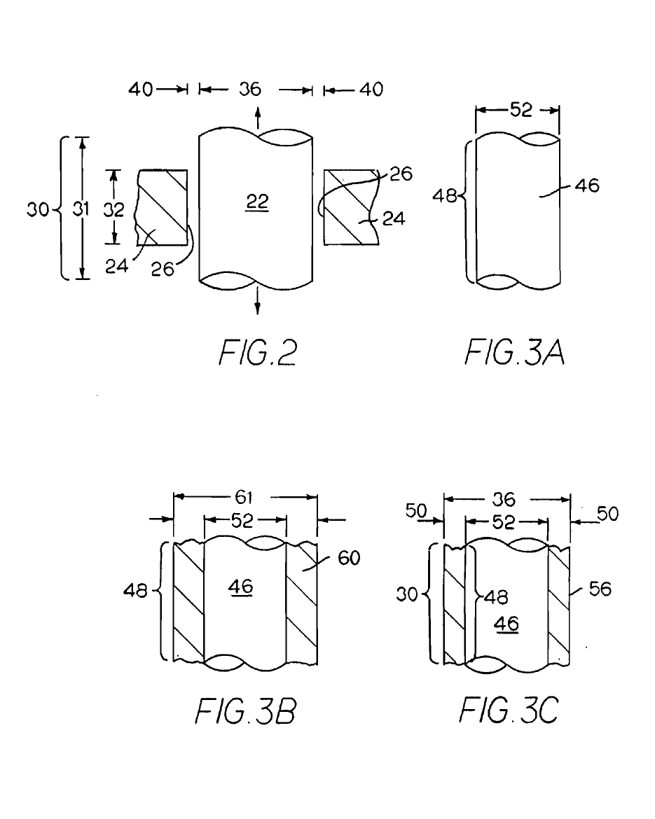

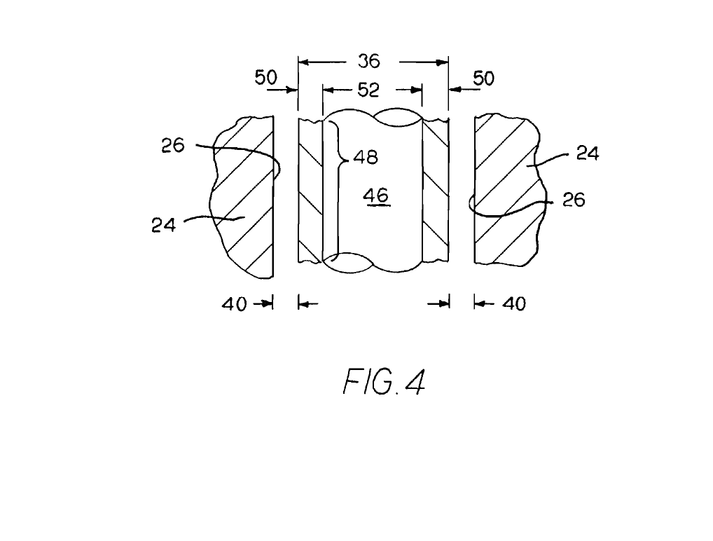

Referring to FIG. 3A, the coated plunger 22 has a substrate 46 which has an undersized substrate region (see bracket 48), which has a reduced size. The undersized substrate region 48 corresponds to the critical region 30 of the coated member 22 previously noted in FIG. 2. In other words, the portion of the substrate that forms the critical region 30 of the coated member 22 is the undersized substrate region 48.

The material for the substrate can vary depending upon the specific application. The substrate can be any one or the following materials: steel (including a low carbon steel), tool steel, stainless steel or superalloys manufactured using casting, machining from rod or sheet, or powder metallurgical techniques. The specific kinds of materials can be a stainless steel such as, for example, CA6NM or a 300 series or a 400 series stainless steel. The substrate may be a steel material such as 4140 or 4340 or the like. Still further, the substrate may be an Inconel® [registered trademark of Huntington Alloys Corporation, Huntington, W. Va. 25705 as shown by Federal Trademark Registration No. 308,200] or a Hastelloy® [registered trademark of Haynes International Inc., Kokomo, Ind. 46904 as shown by Federal Trademark Registration No. 269,898] material or a similar nickel-based alloy.

Referring to FIG. 3C, the undersized substrate region 48 has been undersized an amount equal to a minimum undersizing depth 50 to achieve the reduced size 52. The minimum undersizing depth 50 is equal to about seventy-five percent (75%) of the clearance distance 40. What this means is that the least amount of undersizing of the undersized substrate region 48 is equal to about seventy-five percent (75%) of the clearance distance 40. The undersizing is intended to refer to the dimension of the undersized substrate region 48 relative to the finished size 36 of the coated member 22. The location of the undersized substrate region 48 corresponds to the critical region 30 of the coated member 22. In other words, the undersized substrate region 48 is undersized such that the sum of the reduced size 52 and two times the minimum undersizing depth 50 is equal to the finished size 36. As other alternatives, the extent of the undersizing of the undersized substrate region 48 can equal about eighty percent (80%) or about eighty-five percent (85%), or about ninety percent (90%) or about ninety-five percent (95%) or about one hundred percent (100%) of the clearance distance 40. There is the contemplation that the extent of undersizing the undersized substrate region 48 could exceed one hundred percent (100%) of the clearance distance 40 depending upon the specific application. Further, the coating thickness of the finished coating scheme 56 may be about seventy-five percent (75%) of the average particle size of the particles in the slurry. The typical average particle size ranges between about 25 micrometers and about 200 micrometers.

Referring to FIG. 3C, the coated member 22 has a finished coating scheme 56 on the undersized substrate region 48. Typically, the thickness of the finished coating scheme 56 is greater than about 20 micrometers. The finished coating scheme 56 is the result of an oversized coating scheme 60 (see FIG. 3B) being treated to form the finished coating scheme 56 wherein the coated member 22 is of the finished size 36 in the critical region 30. Techniques to treat the oversized coating scheme 60 to form the finished coating scheme 56 including diamond polishing. Other suitable techniques to treat the oversized coating scheme 60 include grinding or hard turning. There should be an appreciation that the finished coating scheme 56 covers all surfaces of the coated member 22 that are in contact with the erosive and/or corrosive environment.

The composition and coating architecture of the finished coating scheme 56 can vary depending upon the specific application to which the coated member (e.g., plunger) will be a part. In the case of the plunger, the coating scheme can be a monolayer or a nanocomposite of titanium silicon carbonitride or titanium chromium silicon carbonitride or tungsten-tungsten carbide, or a metal oxide, carbide or nitride. As additional exemplary coating schemes, the coating scheme can comprise multilayers wherein the layers can be one of a metal, a ceramic, or a composite. Exemplary metals are titanium, chromium, nickel, zirconium, tungsten, or hafnium. Exemplary ceramic layers are titanium nitride, titanium carbonitride, titanium aluminum nitride, titanium aluminum silicon carbonitride, and tungsten carbide. Exemplary composite layers include tungsten-tungsten carbide, titanium silicon carbonitride (nanocomposite structures), silicon carbonitride, tungsten carbide-cobalt, tungsten carbide-nickel, and nickel-diamond. As an alternative, each one of the above coating schemes can include a bonding coating layer on the substrate. The bonding coating layer can comprise any one of titanium, nickel, chromium or silicon.

One suitable technique to deposit the coating is the plasma enhanced magnetron sputtering (PEMS) process. The PEMS process is shown and described in United States Patent Application Publication No. US2009/0214787A1 to Wei et al. and entitled EROSION RESISTANT COATINGS. Further, the PEMS process is shown and described in the article Wei et al., “Deposition of thick nitrides and carbonitrides for sand erosion protection”, Surface & Coatings Technology, 201 (2006), pp. 4453-4459. Further, suitable coating processes are shown in U.S. Pat. No. 4,427,445 to Holzl et al. and U.S. Pat. No. 6,800,383 to Lakhotkin et al. In addition, the process can include other deposition processes from the vapor phase, e.g., chemical vapor deposition (CVD) or physical vapor deposition (PVD), or from liquid media like a slurry or a chemical solution. These other deposition techniques must satisfy certain process requirements as to a temperature that will not excessively distort the substrate. Typical deposition temperatures are not to exceed 520° C., and as another option, not to exceed 500° C. These other deposition techniques must also satisfy the tool design requirements to achieve the desired dimensional and performance characteristics.

Other beneficial physical properties of the finished coating scheme 56 are: an adhesion using Rockwell indentation strength of greater than 100 Kg; wear resistance using the ASTM G65-04(2010) [“Standard Test Method for Measuring Abrasion Using the Dry Sand/Rubber Wheel Apparatus”] test wherein the wear resistance is greater than 10 times that of an uncoated substrate; a corrosion resistance such as that it is resistant to acids, sulfides and brine solutions; an erosion resistance using the ASTM G76-07 [“Standard Test Method for Conducting Erosion Tests by Solid Particle Impingement Using Gas Jets”] test such that resistance is 2 times the erosion resistance of an uncoated steel substrate or a cemented (cobalt) tungsten carbide substrate; a hardness such that the coating must have a hardness greater than about 1000 HV; the hardness of the substrate must not have been reduced by more than 4 HRC through the application of the coating; the friction coefficient equal to less than 0.4 in ASTM G99 [ASTM G99-05(2010) “Standard Test Method for Wear Testing with a Pin-on-Disk Apparatus”] pin-on-disc wear testing against an alumina (aluminum oxide) ball at 1 GPa stress; and a consistency where there are no visible flaws, no visible flaking, or no visible exposed surfaces, and a consistency of the color over the coated member.

Referring to the series of drawings FIGS. 3A through 3C, this series shows the basic steps in the method for making a coated member 22 adapted for movement relative to a surface 26 wherein a clearance distance 40 between the coated member 22 and the surface 26 exists in a critical region 30 of the coated member 22 and wherein the coated member 22 having a finished size 36 in the critical region 30. The method comprises the following steps.

The first step is to provide a substrate. As mentioned hereinabove, the substrate can be any one or the materials listed hereinabove.

The next step is undersizing the substrate 46 to a minimum undersizing depth 50 to form an undersized substrate region 48. The minimum undersizing depth is consistent along the axial length of the undersized substrate region 48. The undersized substrate region 48 corresponds to the critical region 30 of the coated member 22. The minimum undersizing depth 50 is equal to about 75% of the clearance distance. As other alternatives, the extent of the undersizing the undersized substrate region 48 can equal about eighty percent (80%) or eighty-five percent (85%), or ninety percent (90%) or ninety-five percent (95%) or one hundred percent (100%) of the clearance distance 40. There is the contemplation that the extent of undersizing the undersized substrate region 48 could exceed one hundred percent (100%) of the clearance distance 40 depending upon the specific application.

As an alternative to the first two steps discussed above, i.e., providing the substrate and undersizing the substrate, the method can provide a substrate with an undersized substrate region having a minimum undersizing depth.

The next step is depositing an oversized coating scheme 60 to the undersized substrate region 48. The oversized coating scheme 60 has an oversized size 61 (see FIG. 3B). The oversized coating scheme 60 can comprise multilayers wherein the layers can be one of a metal, a ceramic, or a composite. Exemplary metals are titanium, chromium, nickel, zirconium, tungsten, or hafnium. Exemplary ceramic layers are titanium nitride, titanium carbonitride, titanium aluminum nitride, titanium aluminum silicon carbonitride, and tungsten carbide. Exemplary composite layers include tungsten-tungsten carbide, titanium silicon carbonitride (nanocomposite structures), silicon carbonitride, tungsten carbide-cobalt, tungsten carbide-nickel, and nickel-diamond. It is typical that the coated member with the oversized coating scheme 60 is oversized as compared to the coated member 22 with the finished coating scheme 56 by a small amount such as, for example, a few micrometers. In other words, the difference between oversized size 61 and finished size 36 is on the order of two times a few micrometers. Oversizing by such a small amount minimizes the extent of grinding, polishing or the like necessary to the coated member to reach the finished size. It is beneficial to minimize the extent of grinding, polishing or the like to achieve the finished size.

Specific processes to use to apply the coating are listed hereinabove and include the PEMS process is shown and described in United States Patent Application Publication No. US2009/0214787A1 to Wei et al., the PEMS process as described in the article Wei et al., “Deposition of thick nitrides and carbonitrides for sand erosion protection”, Surface & Coatings Technology, 201 (2006), pp. 4453-4459, the coating processes are shown in U.S. Pat. No. 4,427,445 and U.S. Pat. No. 6,800,383.

The final step is treating the oversized coating scheme 60 to form a finished coating scheme 56 whereby the coated member 22 has the finished size 36 in the critical region 30. For this step, one suitable technique is diamond polishing. A post-coating treatment like diamond polishing can reduce the residual tensile stresses in the coating. Typically, such a reduction is beneficial to the coating properties. Diamond polishing can also bring the coated member 22 into dimensional tolerance specifications and surface finish specifications. The coated member 22 can possess beneficial mechanical and friction properties, as well as the dimensional tolerances along the component exhibiting an acceptable consistency in thickness. Other suitable techniques include diamond grinding, electropolishing or grinding. It is typical that the treating step results in a finished coating scheme 56 that exhibits reduced residual tensile stresses than were in the oversized coating scheme 60.

As an option after completion of the above coating process, the coated member can be subjected to an energy deliver system that impacts the coating surface with enough force to produce a compressive stress zone to a depth in the coating layer thereby providing a means to prevent crack propagation. Exemplary energy delivery systems include shot peening or swaging.

One example (Sample A) was tested against the benchmark material, which is a uncoated AISI Grade 420C stainless steel. Sample A comprised a substrate having a coating scheme deposited thereon. The coating scheme comprised a substrate and a WC/W coating layer applied by chemical vapor deposition (CVD) to the substrate so that it is a CVD-based coating. The WC/W coating had a thickness equal to about 50 microns. For Sample A, the substrate was steel, and the low temperature CVD technique comprised the basic steps of: applying a few microns of nickel metal to the iron-based substrate, heating the part to about 500-520° C. in a vacuum, flowing heated gaseous reaction products over the part, then cooling to room temperature in an inert atmosphere.

Sample A was tested for resistance to acids by immersing it in HCl, H₂SO₄ and HF in a standard chemical immersion test with the reactivity measured by weight change and visual appearance. The friction coefficient was tested using a alumina ball with a ˜1 GPa stress using the ASTM G99-05(2010) [“Standard Test Method for Wear Testing with a Pin-on-Disk Apparatus”] test method. The coating resisted delamination and exhibited low friction. The wear resistance was determined using the ASTM G65-04(2010) [“Standard Test Method for Measuring Abrasion Using the Dry Sand/Rubber Wheel Apparatus”] test method. The results are set forth in Table 1 below.

TABLE 1
Test results for the uncoated steel and the Sample A Coating (WC/W)

| | Benchmark | |
|---|---|---|
| | Uncoated AISI | Sample A with |
| | SS420 | WC/W Coating |
| Resistance to Acids | acceptable | Good |
| Friction Coefficient | 0.7 | 0.3-0.4 |
| (ASTM G99) | | |
| Processing | -NA- | 480-520° C. |
| Temperature | | |
| Wear Resistance | Base line (1X) | >10-40X over |
| (ASTM G65) | | uncoated 400 series SS |

Based on the results in Table 1 above, the coating on Sample A showed a good combination of low temperature deposition, low friction, and good wear resistance. More specifically, the resistance to acids for the coating on Sample A was better than for the uncoated article since a “good” rating is better than an “acceptable” rating. The friction coefficient shows a lower friction for the coating on Sample A as compared to the uncoated article. Finally, the wear resistance for the coating on Sample A is much better, i.e., ten to forty times better, than the wear resistance for the uncoated article.

It is apparent that the present invention provides an improved coated member for movement relative to a surface, and a method for making the coated member, wherein the coating provides resistance against erosion and/or corrosion in an environment requiring tight tolerances between the coated member and the surface.

It is apparent that the present invention provides an improved coated member for movement relative to a surface, and a method for making the coated member, wherein there is a reduction, if not elimination, of expensive grinding procedures necessary to meet the dimensional requirements.

It is apparent that the present invention provides an improved coated member for movement relative to a surface, and a method for making the coated member, wherein the coated member provides erosion and corrosion resistance even when small hard particles become trapped between the coated member and the surface it moves relative to.

It is apparent that the present invention provides an improved coated member for movement relative to a surface, and a method for making the coated member, wherein the coating is of a sufficient thickness so that the sub-surface shear stresses do not extend into the coating-substrate interface or the substrate itself. Further, it is apparent that the present invention provides an improved coated member for movement relative to a surface, and a method for making the coated member, wherein the coating has a sufficient thickness so that the sub-surface shear stresses extend to such a depth as to remain within the coating.

It is apparent that the present invention provides an improved coated member for movement relative to a surface, and a method for making the coated member, wherein the coating scheme comprises a multi-layer coating architecture wherein ductile, corrosion-resistant metal interlayers are between hard ceramic layers so as to provide both ductility and erosion-resistance and corrosion-resistance.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A coated member adapted for movement relative to a surface wherein a clearance distance between the coated member and the surface exists in a critical region of the coated member, the coated member comprising:
the coated member having a finished size in the critical region;
a substrate having an undersized substrate region of a minimum undersizing depth wherein the minimum undersizing depth being equal to about 75% of the clearance distance, and the undersized substrate region corresponding to the critical region of the coated member; and
a finished coating scheme on the undersized substrate region wherein the finished coating scheme is the result of an oversized coating scheme being treated to form the finished coating scheme wherein the coated member being of the finished size in the critical region.

2. The coated member according to claim 1 wherein the coating is at least as thick as 0.75 of the average particle size wherein the average particle size ranges between about 25 and about 200 micrometers.

3. The coated member according to claim 1 wherein the substrate comprises one of the following: steel, tool steel, stainless steel, cast irons, or superalloys using casting, machining from rod or sheet, or powder metallurgical techniques.

4. The coated member according to claim 1 wherein the coated member is a shaft of a pump plunger.

5. The coated member according to claim 1 wherein the coated member is an impeller used to handle erosive and/or corrosive slurries.

6. The coated member according to claim 1 wherein the coating covers all surfaces of the coated member in contact with the erosive and/or corrosive environment.

7. The coated member according to claim 1 wherein the thickness of the coating is greater than 20 micrometers.

8. The coated member according to claim 1 wherein the minimum undersizing depth being equal to one of the following: about 80% of the clearance distance; about 85% of the clearance distance; about 90% of the clearance distance; about 95% of the clearance distance; about 100% of the clearance distance; or greater than about 100% of the clearance distance.

9. The coated member according to claim 1 wherein the clearance distance ranges between about 2 microns and about 250 microns.

10. The coated member according to claim 1 wherein the clearance distance ranges between about 10 microns and about 50 microns.

11. A method for making a coated member adapted for movement relative to a surface wherein a clearance distance between the coated member and the surface exists in a critical region of the coated member and wherein the coated member having a finished size in the critical region, the method comprising the steps of:
providing a substrate with an undersized substrate region having a minimum undersizing depth, the undersized region corresponding to the critical region of the coated member, and wherein the minimum undersizing depth being equal to about 75% of the clearance distance;
depositing an oversized coating scheme to the undersized substrate region; and
finishing the oversized coating scheme to form a finished coating scheme whereby the coated member has the finished size in the critical region.

12. The method according to claim 11 wherein the minimum undersizing depth being equal to one of the following: about 80% of the clearance distance; about 85% of the clearance distance; about 90% of the clearance distance; about 95% of the clearance distance; about 100% of the clearance distance; or greater than about 100% of the clearance distance.

13. The method according to claim 11 wherein the minimum undersizing depth is consistent along the axial length of the undersized substrate region.

14. The method according to claim 11 treating the oversized coating scheme provides a finished coating scheme exhibiting reduced residual tensile stresses.

15. The method according to claim 11 further comprising the step of treating the finished coating scheme with an energy delivery system that impacts the coating surface with enough force to produce a compressive stress zone to a depth in the coating layer thereby providing a prevent crack prevention.

16. The method according to claim 11 wherein the clearance distance ranges between about 2 microns and about 250 microns.

17. The method according to claim 11 wherein the clearance distance ranges between about 10 microns and about 50 microns.
